(19) United States
(12) Patent Application Publication
(10) Pub. No.: US 2019/0385539 A1
(43) Pub. Date: Dec. 19, 2019

(54) SYSTEMS AND METHODS OF MULTIPLE COLOR DRIVING

(71) Applicant: Ignis Innovation Inc., Waterloo (CA)

(72) Inventor: Gholamreza Chaji, Waterloo (CA)

(21) Appl. No.: 16/556,766

(22) Filed: Aug. 30, 2019

Related U.S. Application Data
(63) Continuation of application No. 16/140,899, filed on Sep. 25, 2018, now Pat. No. 10,446,086.
Application No. 16/140,899 is a continuation of application No. 15/293,526, filed on Oct. 14, 2016, now Pat. No. 10,102,808.

(30) Foreign Application Priority Data
Oct. 14, 2015 (CA) 2908285

(51) Int. Cl. G09G 3/3291; G09G 3/20

(52) U.S. Cl. CPC G09G 3/3291; G09G 3/2003; G09G 2310/08; G09G 2310/027; G09G 2310/0286; G09G 2300/0452

(57) ABSTRACT

Systems and methods of color data driving for light emissive visual display technology, and particularly to systems and methods for driving pixels with more than three primary color subpixels. Only a subset of the total number of subpixels per pixel are driven at any one time reducing the number of decoders/DACs. The decoders/DACs are coupled by a color decoder only to the active subpixels using a switching fabric.

### PRIORITY CLAIM

This application claims priority to Canadian Application No. 2,908,285, filed Oct. 14, 2015, which is hereby incorporated by reference herein in its entirety.

### FIELD OF THE INVENTION

The present disclosure relates to color data driving for light emissive visual display technology, and particularly to systems and methods for driving pixels with more than three primary color subpixels in an active matrix light emitting diode device (AMOLED) and other emissive displays.

### BRIEF SUMMARY

According to one aspect, there is provided a color data driver for an emissive display system having pixels, each pixel having a number of primary color subpixels, each primary color subpixel having a light emitting device, the color data driver comprising: data storage for receiving color data for a number of active primary color subpixels of a pixel, the number of active primary color subpixels less than a number of primary color subpixels of the pixel; decoders for performing digital to analog conversion of the color data to generate analog color data, the number of decoders corresponding to a preset maximum number of active primary color subpixels of a pixel which is less than the number of primary color subpixels of the pixel; and a color decoder for receiving the analog color data for the number of active primary color subpixels and for providing the color data for the active primary color subpixels to the pixel, the color decoder comprising: a switch fabric controllable to select a switching state being a combination of switching from color data inputs of the color decoder to color data outputs of the color decoder with use of color bits provided to the color decoder, the switch fabric for, according to the switching state, switching to each color data output one of at least one color data input, and for switching to at least one color data output, one of at least two color data inputs.

In some embodiments, the switch fabric comprises a set of switches for connecting to at least one bias voltage, color data outputs which are not being used for providing to the pixel the color data for the active primary color subpixels. In some embodiments, the at least one bias voltage comprises a different bias voltage for each color data output.

In some embodiments, the color bits uniquely identifies the switching state from a number of preset possible states, the bit length of the color bits corresponding to a shortest bit length required to select any of the switching states from the number of preset possible states. In some embodiments, the number of present possible states is two and the bit length of the color bits is one.

In some embodiments, the number of active primary color subpixels is three, the preset maximum number of active primary color subpixels of a pixel is three, and the number of primary color subpixels of the pixel is four. In some embodiments, the primary color subpixels of the pixel consist of a red subpixel, a green subpixel, a blue subpixel, and a white subpixel. In some embodiments, the color bits uniquely identifies the switching state from four preset possible states and the bit length of the color bits is two, and wherein the switch fabric comprises a set of switches for connecting to at least one bias voltage, color data outputs which are not being used for providing to the pixel the color data for the active primary color subpixels.

In some embodiments, the color decoder receives the analog color data from the decoders via buffers, the number of buffers corresponding to the number of decoders.

In some embodiments, wherein the data storage comprises a switch register for storing the color data and the color bits, and for providing the color bits to the color decoder.

According to another aspect there is provided, a method of data driving for an emissive display system having pixels, each pixel having a number of primary color subpixels, each primary color subpixel having a light emitting device, the method comprising: receiving color data for a number of active primary color subpixels of a pixel, the number of active primary color subpixels less than a number of primary color subpixels of the pixel; performing digital to analog conversion of the color data to generate analog color data using decoders, the number of decoders corresponding to a preset maximum number of active primary color subpixels of a pixel which is less than the number of primary color subpixels of the pixel; receiving by a color decoder the analog color data for the number of active primary color subpixels; and providing by the color decoder the color data for the active primary color subpixels to the pixel with use of a switch fabric, the providing comprising: selecting a switching state being a combination of switching from color data inputs of the color decoder to color data outputs of the color decoder with use of color bits provided to the color decoder; according to the switching state, switching to each color data output one of at least one color data input; and according to the switching state, switching to at least one color data output, one of at least two color data inputs.

In some embodiments, the step of providing further comprises: according to the switching state, connecting to at least one bias voltage, color data outputs which are not being used for providing to the pixel the color data for the active primary color subpixels. In some embodiments, the at least one bias voltage comprises a different bias voltage for each color data output.

In some embodiments, the color bits uniquely identifies the switching state from four preset possible states and the bit length of the color bits is two, and wherein the step of providing further comprises: connecting to at least one bias voltage, color data outputs which are not being used for providing to the pixel the color data for the active primary color subpixels.

In some embodiments, the receiving by the color decoder of the analog color data from the decoders is via buffers, the method further comprising: receiving by buffers the analog color data from the decoders, the number of buffers corresponding to the number of decoders.

Some embodiments further provide for: storing the color data and the color bits in a switch register; and providing the color bits from the switch register to the color decoder.

The foregoing and additional aspects and embodiments of the present disclosure will be apparent to those of ordinary skill in the art in view of the detailed description of various embodiments and/or aspects, which is made with reference to the drawings, a brief description of which is provided next.

### BRIEF DESCRIPTION OF THE DRAWINGS

The foregoing and other advantages of the disclosure will become apparent upon reading the following detailed description and upon reference to the drawings.

FIG. 1A illustrates a known pixel with more than three primary color subpixels;

FIG. 1B illustrates known multiple color driving of a pixel with more than three primary color subpixels;

FIG. 2 illustrates an example display system which participates in and whose pixels are to be driven with use of the color driving systems and methods disclosed;

FIG. 3 illustrates a multiple color data driver according to an embodiment; and

FIG. 4 illustrates a color decoder of a multiple color data driver according to an embodiment.

While the present disclosure is susceptible to various modifications and alternative forms, specific embodiments or implementations have been shown by way of example in the drawings and will be described in detail herein. It should be understood, however, that the disclosure is not intended to be limited to the particular forms disclosed. Rather, the disclosure is to cover all modifications, equivalents, and alternatives falling within the spirit and scope of an invention as defined by the appended claims.

### DETAILED DESCRIPTION

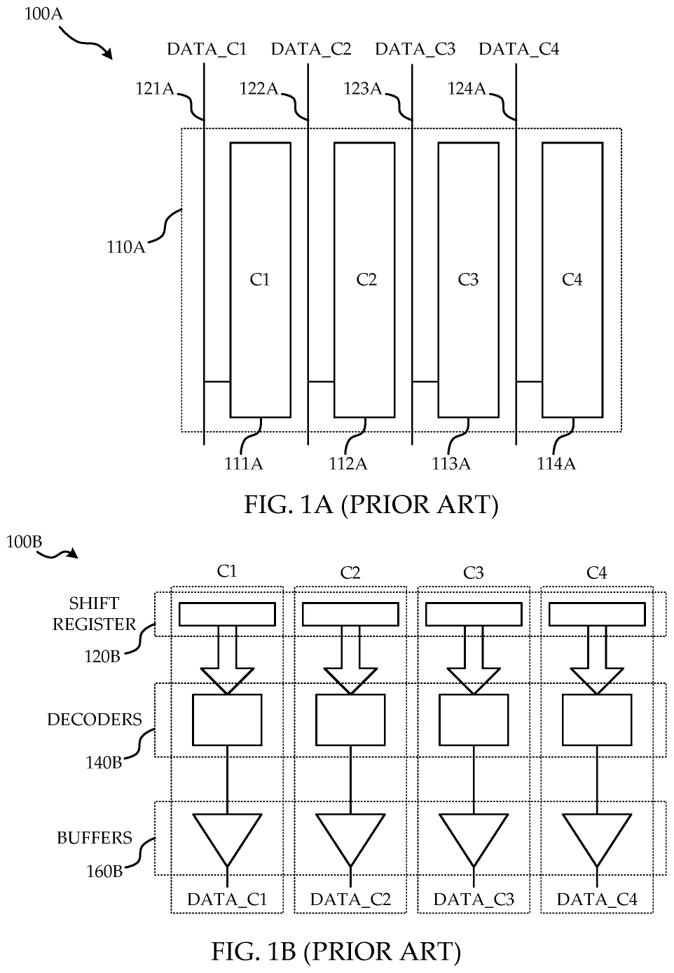

For several reasons such as ease of manufacturing, wider color gamut, lower power consumption, among others, it is often preferred to use more than three primary color subpixels. In one example, each pixel consists of red, green, blue and white subpixels. FIG. 1A depicts a known pixel 100A with four primary color subpixels, 111A (C1), 112A (C2), 113A (C3), and 114A (C4), where primary colors C1, C2, C3, and C4, correspond, for example, to red, green, blue and white respectively. In such a case, the data is converted from RGB to RGBW at the image processors or at the controller or timing controller (TCON) and then passed to the data driver. As a result, each driver channel for a pixel requires at least four outputs to the pixel (in other cases it may require more outputs depending upon the number of primary color subpixels). For example, in FIG. 1A, red data is output over data line DATA_C1 121A, green data is output over data line DATA_C2 122A, blue data is output over data line DATA_C3 123A, and white data is output over data line DATA_C4 124A.

FIG. 1B shows an example of a known driver channel 100B for a 4-subpixel pixel structure such as that illustrated in FIG. 1. The driver channel 100B consists of four parallel channels, one for each primary color C1, C2, C3, and C4, each utilizing a portion of shift registers 120B, decoders 140B, and buffers 160B. The digital data is passed to the data driver through shift registers 120B or through a combination of shift registers and latches. The digital data is converted into the analog domain through DACs (digital to analog converters) of which the decoders 140B comprise. The converted analog voltage is used to drive the panel through buffers 160B. The output of the buffers DATA_C1, DATA_C2, DATA_C3, and DATA_C4, constitute the primary color data which is input to a pixel such as that depicted in FIG. 1A.

The main issue with this structure and method of driving is that the data transfer rate to the data driver is increased by an amount corresponding to the number of extra primary colors. In the case of using an RGBW structure, the data rate is 25% more than the typical RGB data driver. This is more of a challenge in the case of higher resolution displays and higher frame rates. For a 4K display running at 120 Hz, the data rate is 3.7 GB/s using an RGB structure, while the date rate for the same display is 4.9 GB/s using RGBW. Another challenge of known systems using RGBW versus RGB is that the size of the driver increases by 25% causing more cost and power consumption.

Providing in accordance with known driving techniques, a parallel and additional channel for every primary color beyond three leads to a proportional increase in data rate, driver size, increasing costs and power consumption.

While the embodiments described herein below are in the context of AMOLED displays it should be understood that the systems and methods described herein are applicable to any other display comprising pixels having more than three primary color subpixels, including but not limited to light emitting diode displays (LED), electroluminescent displays (ELD), organic light emitting diode displays (OLED), plasma display panels (PSP), among other displays.

It should be understood that the embodiments described herein pertain to systems and methods of driving are not limited to any particular display technology underlying their operation and the operation of the displays in which they are implemented. The systems and methods described herein are applicable to any number of various types and implementations of various visual display technologies.

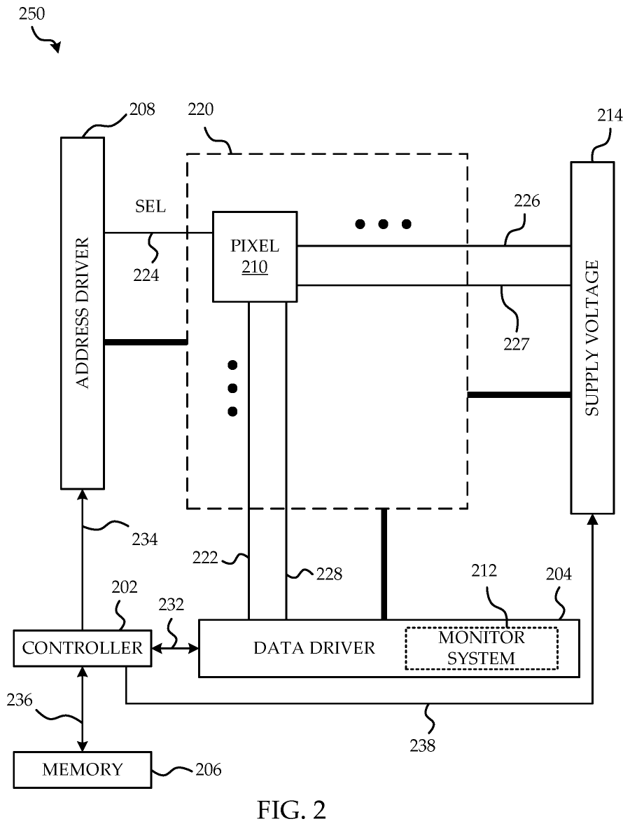

FIG. 2 is a diagram of an example display system 250 implementing systems and methods described further below. The display system 250 includes a display panel 220, an address driver 208, a data driver 204, a controller 202, and a memory storage 206.

The display panel 220 includes an array of pixels 210 (only one explicitly shown) arranged in rows and columns. Each of the pixels 210 is individually programmable to emit light with individually programmable luminance values. The controller 202 receives digital data indicative of information to be displayed on the display panel 220. The controller 202 sends signals 232 to the data driver 204 and scheduling signals 234 to the address driver 208 to drive the pixels 210 in the display panel 220 to display the information indicated. The plurality of pixels 210 of the display panel 220 thus comprise a display array or display screen adapted to dynamically display information according to the input digital data received by the controller 202. The display screen can display images and streams of video information from data received by the controller 202. The supply voltage 214 provides a constant power voltage or can serve as an adjustable voltage supply that is controlled by signals from the controller 202. The display system 250 can also incorporate features from a current source or sink (not shown) to provide biasing currents to the pixels 210 in the display panel 220 to thereby decrease programming time for the pixels 210.

For illustrative purposes, only one pixel 210 is explicitly shown in the display system 250 in FIG. 2. It is understood that the display system 250 is implemented with a display screen that includes an array of a plurality of pixels, such as the pixel 210, and that the display screen is not limited to a particular number of rows and columns of pixels. For example, the display system 250 can be implemented with a display screen with a number of rows and columns of pixels commonly available in displays for mobile devices, monitor-based devices, and/or projection-devices. In a multichannel or color display, a number of different types of pixels, each responsible for reproducing color of a particular channel or color such as red, green, blue, or white will be present in the display. Pixels of this kind may also be referred to as “subpixels” as a group of them collectively provide a desired color at a particular row and column of the display, which group of subpixels may collectively also be referred to as a “pixel”.

The subpixels of the pixel 210 are operated by a driving circuit or pixel circuit that generally includes a driving transistor and a light emitting device. The light emitting device can optionally be an organic light emitting diode, but implementations of the present disclosure apply to pixel circuits having other electroluminescence devices, including current-driven light emitting devices and those listed above. The driving transistor in the pixel 210 can optionally be an n-type or p-type amorphous silicon thin-film transistor, but implementations of the present disclosure are not limited to pixel circuits having a particular polarity of transistor or only to pixel circuits having thin-film transistors. The pixel circuit 210 can also include a storage capacitor for storing programming information and allowing the pixel circuit 210 to drive the light emitting device after being addressed. Thus, the display panel 220 can be an active matrix di splay array.

As illustrated in FIG. 2, the pixel 210 illustrated as the top-left pixel in the display panel 220 is coupled to a select lines 224, a supply line 226, a data lines 222, and a monitor line 228. A read line may also be included for controlling connections to the monitor line. In one implementation, the supply voltage 214 can also provide a second supply line to the pixel 210. For example, each pixel can be coupled to a first supply line 226 charged with Vdd and a second supply line 227 coupled with Vss, and the pixel circuits 210 can be situated between the first and second supply lines to facilitate driving current between the two supply lines during an emission phase of the pixel circuit. It is to be understood that each of the pixels 210 in the pixel array of the display 220 is coupled to appropriate select lines, supply lines, data lines, and monitor lines. It is noted that aspects of the present disclosure apply to pixels having additional connections, such as connections to additional select lines, and to pixels having fewer connections.

With reference to the pixel 210 of the display panel 220, the select lines 224 is provided by the address driver 208, and can be utilized to enable, for example, a programming operation of the pixel 210 by activating a switch or transistor to allow the data lines 222 to program the various subpixels of the pixel 210. The data lines 222 convey programming information from the data driver 204 to the pixel 210. For example, the data lines 222 can be utilized to apply programming voltages or programming current to the subpixels of the pixel 210 in order to program the subpixels of the pixel 210 to emit a desired amount of luminance. The programming voltages (or programming current) supplied by the data driver 204 via the data lines 222 are voltages (or currents) appropriate to cause the subpixels of the pixel 210 to emit light with a desired amount of luminance according to the digital data received by the controller 202. The programming voltages (or programming currents) can be applied to the subpixels of the pixel 210 during a programming operation of the pixel 210 so as to charge storage devices within the subpixels of the pixel 210, such as a storage capacitor, thereby enabling the subpixels of the pixel 210 to emit light with the desired amount of luminance during an emission operation following the programming operation. For example, the storage device in a subpixel of the pixel 210 can be charged during a programming operation to apply a voltage to one or more of a gate or a source terminal of the driving transistor during the emission operation, thereby causing the driving transistor to convey the driving current through the light emitting device according to the voltage stored on the storage device.

Generally, in each subpixel of the pixel 210, the driving current that is conveyed through the light emitting device by the driving transistor during the emission operation of the pixel 210 is a current that is supplied by the first supply line 226 and is drained to a second supply line 227. The first supply line 226 and the second supply line 227 are coupled to the voltage supply 214. The first supply line 226 can provide a positive supply voltage (e.g., the voltage commonly referred to in circuit design as “Vdd”) and the second supply line 227 can provide a negative supply voltage (e.g., the voltage commonly referred to in circuit design as “Vss”). Implementations of the present disclosure can be realized where one or the other of the supply lines (e.g., the supply line 227) is fixed at a ground voltage or at another reference voltage.

The display system 250 also includes a monitoring system 212. With reference again to the pixel 210 of the display panel 220, the monitor line 228 connects the pixel 210 to the monitoring system 212. The monitoring system 212 can be integrated with the data driver 204, or can be a separate stand-alone system. In particular, the monitoring system 212 can optionally be implemented by monitoring the current and/or voltage of the data line 222 during a monitoring operation of the pixel 210, and the separate monitor line 228 can be entirely omitted.

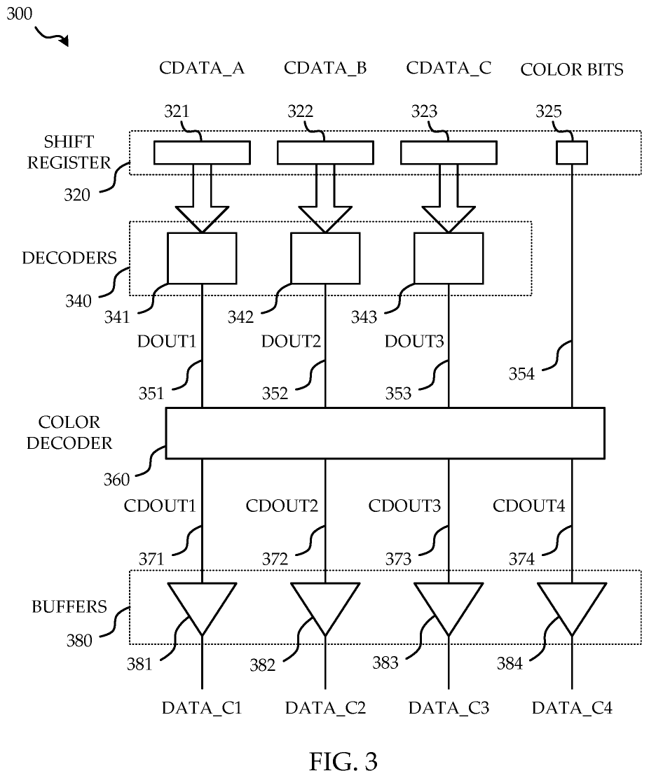

Referring to FIG. 3, a multiple color data driver 300 according to an embodiment will now be described. The data driver 300 and associated methods address the challenges associated with the use of extra color output for a pixel i.e. for dealing with pixels having more than four primary color subpixels. In most of cases, only a subset of the primary color subpixels are active for each color mapping. For example, a color mapping from RGB to RGBW by the image processors or the controller for any particular color might only use three (or possibly fewer) of the primary color subpixels R, G, B, and W. In such a case, the number of outputs of the data driver 300 for a channel, corresponding to the number of primary color subpixels of a pixel in a column, is more than the total number of active primary color subpixels emitting light, at any one time, which in the case illustrated is three (or less). The data driver 300 therefore, uses fewer decoders 341, 342, 343, and hence fewer DACs along with a color decoder 360, described below, in order to provide color data signals to all the primary color subpixels of a pixel only as required. Once a maximum number S of simultaneously active primary color subpixels per pixel is determined, for example as illustrated S=3, this number is used to define the number of decoders and hence DACs for each pixel. The color decoder 360 is used to align each of the DACs outputs to different outputs depending on the color value. The color decoder 360 can use the data passed to the source driver by the TCON or the image processor to align the DACs or it can calculate the DACs' status by itself based on color values.

FIG. 3 shows an example of data driver 300 structure using a color decoder 360. In accordance with a particular color mapping from RGB to RGBW, color data is provided to the shift register 320. Thus the color data includes values only for those primary color subpixels that are active for the mapping. Since the portions of the shift register 320 do not correspond to a unique particular primary color in a static manner, color data to be stored in the shift register are designated in FIG. 3 as CDATA_A, CDATA_B, and CDATA_C each stored respectively in first second and third shift register portions 321, 322, 323 of the shift register 320. Color data CDATA_A, CDATA_B, and CDATA_C are output from the shift registers 321, 322, 323, to respective decoders 341, 342, 343, each including a DAC for converting the digital color data CDATA_A, CDATA_B, and CDATA_C into respective analog decoder outputs, DOUT1 351, DOUT2 352, DOUT3 353.

In addition to color data for the three active primary colors, color bits are provided to the shift register 320 which determines which of the primary color subpixels each of the color data values, CDATA_A, CDATA_B, CDATA_C corresponds to. For example, for a particular color mapping, color bits would designate CDATA_A as data for the red subpixel, CDATA_B as data for the blue subpixel, and CDATA_C as data for the white subpixel. In FIG. 3 the color bits are illustrated as being provided to the driver 300 in a color bits portion 325 of the shift register 320. Alternatively the color bits can be provided with a separate shift register (not shown). In the case color bits is part of the main shift register 320, the bit mapping can be any combination as is apparent to persons of skill in the art. For example, in some cases, the color bits are assigned at the end (or beginning) of the shift register data for a pixel.

The color bits contain enough information for the color decoder 360 to determine how to switch the analog color data DOUT1, DOUT2, DOUT3, input to the color decoder 360, as outputs of the color decoder CDOUT1 371, CDOUT2 372, CDOUT3 373, CDOUT4 374, where each output of the color decoder CDOUT1, CDOUT2, CDOUT3, CDOUT4, corresponds to a respective primary color subpixel. These analog voltages output from the color decoder 360 are used to drive buffers 380 which include a respective buffer 381, 382, 383, 384 for each output of the color decoder 360. The drive buffers 381, 382, 383, 384 output drive signals DATA_C1, DATA_C2, DATA_C3, DATA_C4 which constitutes the primary color data which is provided to the pixel.

In some embodiments, rather than located after the color decoder 360, the buffers 380 can be located between the decoders 340 and the color decoder 360 to share the buffers between active outputs. In such a case the number of buffers is reduced to equal the number of decoders, which in this case is three.

In the example embodiment depicted in FIG. 3 a four-color sub-pixel pixel structure is contemplated. In this case, only three primary color subpixels are active at any one time for color point. Table 1 shows an example of the possible combinations of active primary color sub-pixels for a four-color sub-pixel structure, where colors A, B, and C are the three active subpixels and C1, C2, C3, and C4, are for example, R, G, B, W. It is obvious to an expert in the art that the combination of active colors can be different and can be in different coordination and correspond to different primary colors such as yellow, magenta, etc.

TABLE 1
An example of active color for a four-color sub-pixel

| Color A | Color B | Color C |
|---|---|---|
| C1 | C2 | C3 |
| C1 | C2 | C4 |
| C1 | C3 | C4 |
| C2 | C3 | C4 |

As can be seen in table 1, there are four possible modes or combinations of three active primary color subpixels out of four primary subpixels per pixel. If every combination consists of S active subpixels from a total number of N primary color subpixels per pixel, the number of combinations is S-choose-N or S!/N!*(S−N)!, S<N. In the case illustrated, since there are four possible modes or combinations, a 2-bit “color bits” would be sufficient to designate which of the four modes or combinations is applicable. In some cases, not every color mapping will require the same number of active primary color subpixels. For example it may be desired that for some colors only a mapping to two or even one primary color subpixel be applied. In such a case the number of possibilities may increase. For example, (R,G,W), (R,B,W), (G,B,W), (R,G,B), and (W) may be desired and as such they may form the preset states the color decoder will operate in. In other embodiments there may be a limited set of combinations such as (C1, C2, C3) and (C2, C3, C4) in which case the number of preset modes decreases. In this particular case with only two modes, a single bit “color bits” would suffice to convey to the color decoder 360 which combination is applicable. Generally speaking, the data driver and associated driving method contemplates any number of possible combinations for which only a subset of primary color subpixels of a pixel are used at any one time.

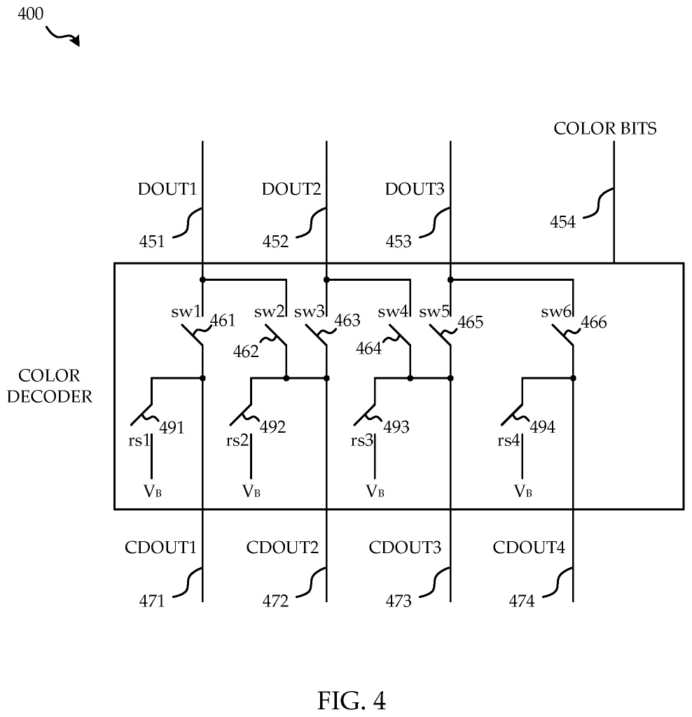

With reference also to FIG. 4, a color decoder 400 according to an embodiment will now be described.

The color decoder 400 takes as inputs 451, 452, 453, the analog color data DOUT1, DOUT2, DOUT3 output from the decoders, as well as color bits 454 input directly from the shift register.

The color decoder 400 includes a switch fabric having a number of switches for connecting particular inputs 451, 452, 453 of the color decoder 400 to particular color data outputs 471, 472, 473, 474 in accordance with the particular mode or combination as determined by the color bits 454, which is also referred to as a switch state. The switches of the switch fabric are used to enable different active outputs 471, 472, 473, 474 to be connected to particular inputs 451, 452, 453 from the decoders (hence the DACs). For example, in one case of “C1, C2, C3”, the ON switches are sw1 461, sw3 463, and sw5 465 as well as reset switch rs4 494 to connect the output for C4 to a bias voltage. The inactive outputs are connected to a bias voltage “V_{B}”. The bias voltage can be different for each output or it can be the same for all outputs. The result is that the active output color data CDOUT1 471, CDOUT2 472, CDOUT3 473, CDOUT4 474, if corresponding to an active primary color subpixel, includes the corresponding color data input to the color decoder 400 DOUT1, DOUT2, DOUT3, and if corresponding to a non-active subpixel, includes only a bias voltage “V_{B}”.

Table 2 summarizes the states of the switches of the color decoder 400 depicted in FIG. 4 for driving the particular pixel combinations as summarized in Table 1.

TABLE 2
An example of color decoder functions.

| | sw1 | sw2 | sw3 | sw4 | sw5 | sw6 | rs1 | rs2 | rs3 | rs4 |
|---|---|---|---|---|---|---|---|---|---|---|
| C1, C2, C3 | ON | OFF | ON | OFF | ON | OFF | OFF | OFF | OFF | ON |
| C1, C2, C4 | ON | OFF | ON | OFF | OFF | ON | OFF | OFF | ON | OFF |
| C1, C3, C4 | ON | OFF | OFF | ON | OFF | ON | OFF | ON | OFF | OFF |
| C2, C3, C4 | OFF | ON | OFF | ON | OFF | ON | ON | OFF | OFF | OFF |

Each output of the color decoder 400 is coupled via a reset switch 491, 492, 493, 494, to a bias voltage or voltages, and two outputs of the color decoder are each couplable via the switches 462, 463, 464, 465 to more than one input of the color decoder. All the switches of the switching fabric 491, 492, 493, 494, 462, 463, 464, 465 are operated so that each output is coupled to only one of a voltage bias or one particular input at any one time.

It should be understood that there are a number of various possible configurations of switches in switch fabrics for switching the inputs of the color decoder 400 to the active outputs in accordance with the teachings above.

Referring once again to FIG. 3, generally each output of the color decoder 360 corresponding to a primary color subpixel which can be inactive is connected in the color decoder 360 via switch fabric to a bias voltage, and each output of the color decoder 360 corresponding to a primary color which can be active is couplable in the color decoder via switch fabric to one or more inputs of the color decoder 360. According to the switch state, each color output is coupled to only to a voltage bias or only to one input of the one or more inputs at any one time.

While particular implementations and applications of the present disclosure have been illustrated and described, it is to be understood that the present disclosure is not limited to the precise construction and compositions disclosed herein and that various modifications, changes, and variations can be apparent from the foregoing descriptions without departing from the spirit and scope of an invention as defined in the appended claims.

1-20. (canceled)

21. A display system comprising:
an array of pixels, each pixel having a plurality of primary color subpixels, each primary color subpixel having a light emitting device; and
a data driver for programming each pixel with color data, the data driver including:
data storage for storing color data for a plurality of active primary color subpixels of the pixel, the active primary color subpixels consisting of a subset of the primary color subpixels of the pixel; and
a switch fabric controllable to receive from the data storage the color data for the active primary color subpixels of the pixel and to steer the color data for the active primary color subpixels to the active primary color subpixels of the pixel.

22. The display system of claim 21, wherein the switch fabric comprises:
color data inputs; and
color data outputs, the number of color data inputs less than the number of color data outputs.

23. The display system of claim 21, wherein the switch fabric comprises:
color data inputs;
color data outputs; and
a plurality of switches controllable for switching to at least one color data output one of a plurality of different color data inputs, and switching at least one color data input to one of a plurality of different color data outputs.

24. The display system of claim 21, wherein the switch fabric comprises a set of switches controllable for connecting to at least one bias voltage, color data outputs of the switch fabric which are not being used for providing to the pixel the color data for the active primary color subpixels.

25. The display system of claim 24 wherein the at least one bias voltage comprises a different bias voltage for each color data output.

26. The display system of claim 24 further comprising a color decoder configured to control the switch fabric to a selected switching state of the switch fabric according to color bits which uniquely identifies the selected switching state from a number of preset possible states.

27. The display system of claim 21, further comprising a color decoder configured to control the switch fabric to a selected switching state of the switch fabric according to color bits which uniquely identifies the selected switching state from a number of preset possible states.

28. The display system of claim 21, further comprising decoders for receiving the color data from the data storage and for performing digital to analog conversion of the color data to generate analog color data, the number of decoders corresponding to a preset maximum number of active primary color subpixels of a pixel which is less than the number of primary color subpixels of the pixel, and wherein the color data received by the switch fabric comprises the analog color data.

29. The display system of claim 28, wherein the switch fabric receives the analog color data from the decoders via buffers, the number of buffers corresponding to the number of decoders.

30. The color data driver of claim 21, wherein the data storage comprises a shift register for storing the color data.

31. A method of data driving for a display system having pixels, each pixel having a plurality of primary color subpixels, each primary color subpixel having a light emitting device, the method comprising:
storing color data for a plurality of active primary color subpixels of a pixel, the active primary color subpixels consisting of a subset of the primary color subpixels of the pixel;
receiving by a switch fabric the color data for the plurality of active primary color subpixels for the pixel; and
controlling the switch fabric to steer the color data for the active primary color subpixels to the active primary color subpixels of the pixel.

32. The method of claim 31, wherein said switch fabric includes color data inputs and color data outputs, the number of color data inputs less than the number of color data outputs.

33. The method of claim 31, wherein said switch fabric includes color data inputs and color data outputs, and wherein said controlling the switch fabric further comprises:
switching to at least one color data output one of a plurality of different color data inputs; and
switching at least one color data input to one of a plurality of different color data outputs.

34. The method of claim 31, wherein said controlling the switch fabric further comprises:
connecting to at least one bias voltage, color data outputs of the switch fabric which are not being used for providing to the pixel the color data for the active primary color subpixels.

35. The method of claim 34, wherein the at least one bias voltage comprises a different bias voltage for each color data output.

36. The method of claim 34, wherein said controlling the switch fabric further comprises:
controlling the switch fabric to a selected switching state of the switch fabric according to color bits which uniquely identifies the selected switching state from a number of preset possible states.

37. The method of claim 31, wherein said controlling the switch fabric further comprises:
controlling the switch fabric to a selected switching state of the switch fabric according to color bits which uniquely identifies the selected switching state from a number of preset possible states.

38. The method of claim 31 further comprising:
receiving the stored color data and performing digital to analog conversion of the color data to generate analog color data using decoders, the number of decoders corresponding to a preset maximum number of active primary color subpixels of a pixel which is less than the number of primary color subpixels of the pixel, wherein receiving by the switch fabric the color data comprises receiving by the switch fabric the analog color data.

39. The method of claim 38, wherein the receiving by the switch fabric of the analog color data from the decoders is via buffers, the method further comprising:
receiving by buffers the analog color data from the decoders, the number of buffers corresponding to the number of decoders.

40. The method of claim 31, further comprising:
storing the color data in a shift register.
